(19) United States
(12) Patent Application Publication
(10) Pub. No.: US 2025/0156167 A1
(43) Pub. Date: May 15, 2025

(54) CLOUD AND EDGE-BASED COMPUTING DEVICE FOR OPERATING AI SERVICE AND METHOD OF MANAGING DEEP LEARNING MODEL THEREOF

(71) Applicant: Korea Electronics Technology Institute, Seongnam-si (KR)

(72) Inventors: Seung Woo Kum, Yongin-si (KR); JaeWon Moon, Seoul (KR); JeongCheol Yeom, Seoul (KR); Seungtaek Oh, Seoul (KR)

(21) Appl. No.: 18/915,125

(22) Filed: Oct. 14, 2024

(30) Foreign Application Priority Data
Nov. 9, 2023 (KR) 10-2023-0154794

(51) Int. Cl. G06F 8/61

(52) U.S. Cl. CPC G06F 8/61

(57) ABSTRACT

Proposed is a computing device for operating an artificial intelligence (AI) service. The computing device may include a local intelligence storage, in which a deep learning model for AI applications based on a container is stored. The computing device may also include a local intelligence/model management unit configured to scan the local intelligence storage to identify information on the deep learning model installed in the computing device and provide the identified information on the deep learning model through a network interface. The local intelligence/model management unit may manage the deep learning model to be stored on the local intelligence storage that is independent from the container.

### CROSS-REFERENCE TO RELATED APPLICATION

This application claims priority to and the benefit of Korean Patent Application No. 10-2023-0154794, filed on Nov. 9, 2023, the disclosure of which is incorporated herein by reference in its entirety.

### BACKGROUND

### Technical Field

The present disclosure relates to a cloud and edge-based computing device for operating an artificial intelligence (AI) service and a method of managing a deep learning model thereof.

### Discussion of Related Technology

The development of deep learning services and cloud and edge computing architectures has brought about significant changes to the field of artificial intelligence (AI) services, and with the development of deep learning technology, various AI services have emerged and expanded. These AI services are primarily provided by utilizing cloud and edge computing architectures.

### SUMMARY

One aspect is a cloud and edge-based computing device for operating an AI service that can independently manage a deep learning model, which is used in an artificial intelligent (AI) application that operates based on a container in a computing device, such as a cloud device and an edge device, from the container, and a method of managing a deep learning model thereof.

The technical aspects of the present disclosure are not limited to the above, and other aspects that are not described above may become apparent to those of ordinary skill in the art based on the following descriptions.

Another aspect is a computing device for operating an artificial intelligence (AI) service, which includes: a local intelligence storage, in which a deep learning model for AI applications based on a container is stored, and a local intelligence/model management unit configured to scan the local intelligence storage to identify information on the deep learning model installed in the computing device, and provide the identified information on the deep learning model through a network interface. The local intelligence/model management unit manages the deep learning model to be stored on the local intelligence storage that is independent from the container.

In some embodiments of the present disclosure, the local intelligence storage may be configured independently from the computing device.

In some embodiments of the present disclosure, the local intelligence storage may be configured as a specific volume within a storage of the computing device.

In some embodiments of the present disclosure, the information on the deep learning model may include information related to at least one of a model name, a model version, a model creator, and a model operating environment of the deep learning model.

In some embodiments of the present disclosure, the local intelligence/model management unit may, upon receiving an installation request of a deep learning model through the network interface, install the deep learning model corresponding to the installation request to be located on the local intelligence storage.

In some embodiments of the present disclosure, the local intelligence/model management unit may broadcast information on the installed deep learning model to the container within computing resources.

Another aspect is a method of managing a deep learning model in a computing device, which includes: storing a deep learning model for an artificial intelligence (AI) application based on a container in a local intelligence storage that is independent from the container; scanning the local intelligence storage to identify information on the deep learning model installed on the computing device; and providing the identified information on the deep learning model through a network interface.

In some embodiments of the present disclosure, the method may further include: receiving an installation request of a deep learning model through the network interface; installing the deep learning model corresponding to the installation request to be located on the local intelligence storage; and broadcasting information on the installed deep learning model to the container within computing resources.

Another aspect is other methods and systems for implementing the present disclosure, and a computer-readable recording medium on which a computer program for executing the method is recorded.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings.

FIG. 1 is a diagram illustrating a technique of managing deep learning models in units of application containers.

FIG. 2 is a diagram illustrating a functional configuration of a cloud and edge-based computing device according to an embodiment of the present disclosure.

FIG. 3 is a flowchart of a method of managing deep learning models in a computing device according to an embodiment of the present disclosure.

FIG. 4 is a block diagram illustrating a configuration of a computing device according to an embodiment of the present disclosure.

### DETAILED DESCRIPTION

Stand-alone edges were mainly used, but with the development of cloud and edge computing technologies, computing resources between edge devices have been federated, enabling cloud-based edge management. This has provided an efficient edge computing environment through network connectivity and cooperative resource utilization.

On the other hand, deploying AI services as containers provides many advantages in terms of efficiency and scalability. Containerized applications, including rich environment and dependency information, achieve high portability and execute in various environments, and have the benefit of facilitating rapid deployment and management of AI services.

However, when a deep learning model is executed inside a container, the model becomes dependent on the container. Accordingly, each container deployed on edge devices has its own deep learning model, and when per-application deep learning model management techniques are used, many constraints on the utilization and management of deep learning models occur.

Hereinafter, the advantages and features of the present disclosure and ways of achieving them will become readily apparent with reference to the detailed description of the following embodiments in conjunction with the accompanying drawings. However, the present disclosure is not limited to such embodiments and may be embodied in various forms. The embodiments to be described below are provided only to complete the disclosure of the present disclosure and assist those of ordinary skill in the art in fully understanding the scope of the present disclosure, and the scope of the present disclosure is defined only by the appended claims.

Terms used herein are used to aid in the description and understanding of the embodiments and are not intended to limit the scope and spirit of the present disclosure. It should be understood that the singular forms “a” and “an” also include the plural forms unless the context clearly dictates otherwise. The terms “comprise,” “comprising,” “include,” and/or “including” used herein specify the presence of stated features, integers, steps, operations, elements, components and/or groups thereof and do not preclude the presence or addition of one or more other features, integers, steps, operations, elements, components, and/or groups thereof. In connection with assigning reference numerals to elements in the drawings, the same reference numerals are used for designating the same elements throughout the specification, and the term “and/or” includes any one or combinations of the associated listed items. It should be understood that, although the terms “first,” “second,” etc. may be used herein to describe various elements, these elements are not limited by these terms. These terms are only used for distinguishing one element from another. For example, a first element could be a second element without departing from the scope of the present disclosure.

Unless otherwise defined, all terms (including technical and scientific terms) used herein have the same meanings as commonly understood by those of ordinary skill in the art to which this invention belongs. It should be further understood that terms, such as those defined in commonly used dictionaries, should not be interpreted in an idealized or overly formal sense unless expressly defined herein specifically.

To aid in the understanding of the present disclosure, the background of the present disclosure will first be described.

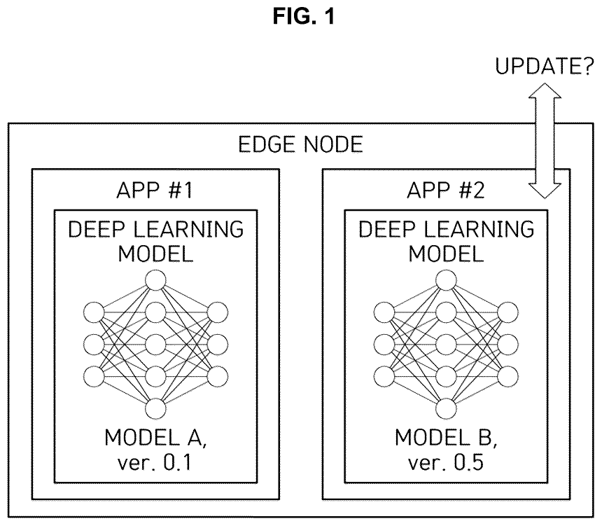

FIG. 1 is a diagram illustrating a technique of managing deep learning models in units of application containers according to the conventional technology.

Recently, edge management techniques utilizing cloud technology (Kubernetes, etc.) have been gaining attention. Kubernetes, a cloud technology, started as a common tool that manages resource orchestration/federation and supports the deployment and management of application containers in a cloud environment, but recently, the use of Kubernetes has expanded not only to cloud resources but also to edge computing environments in remote locations.

In addition, MicroK8s and the like provide lightweight software forms that enable Kubernetes to operate in edge environments, and thus provision of resources to software is achieved in various ways.

However, when utilizing Kubernetes as described above, AI applications are designed to take the form of containers. Kubernetes provides deployment of applications for cloud resources or edge (remote) resources, and in order to support the deployment, applications are configured to take the form of containers. In other words, AI applications need to be containerized. In this case, deep learning models are typically configured to depend on containers. That is, a deep learning model is present (dependent) within a single container. Such a configuration is utilized for a deployment technique in which a deep learning model is included within an application and deployed together with the application.

Such a configuration of including and managing a deep learning model within a container has advantages in portability and deployment as a single package, but when a deep learning model is newly trained due to data updates, etc., the conventional configuration is not considered efficient in a redeployment process for the deep learning model.

That is, when a deep learning model is newly trained, the re-trained deep learning model alone cannot be redeployed, and the entire container needs to be reconfigured and then the new container needs to be deployed. This causes a delay in service application due to container build (configuration) and deployment, and increases the delay due to deployment.

In order to resolve these issues, an embodiment of the present disclosure is provided to effectively support management and deployment of deep learning models, and uses a method of separating an AI application and a deep learning model within a container. That is, an embodiment of the present disclosure proposes a deep learning model management technique performed in units of resources, rather than in units of containers or AI applications, for a deep learning model operating based on a container.

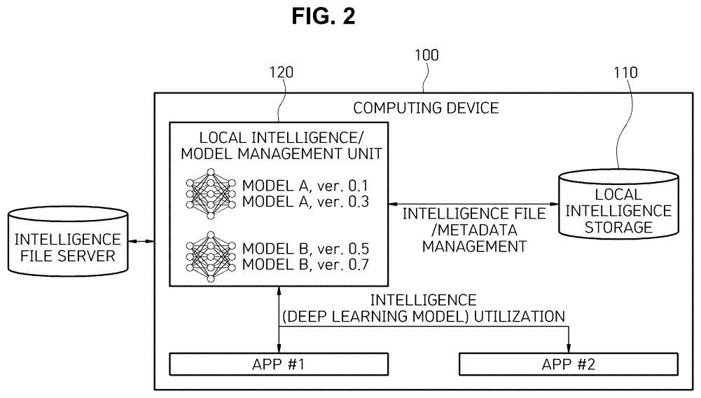

FIG. 2 is a diagram illustrating a functional configuration of a cloud and edge-based computing device 100 according to an embodiment of the present disclosure.

The computing device 100 according to the embodiment of the present disclosure includes a local intelligence storage 110 and a local intelligence/model management unit 120. In this case, the computing device 100 may be a cloud or edge device.

The local intelligence storage 110 stores a deep learning model used in a container-based AI application. In this case, the embodiment of the present disclosure is characterized in that a deep learning model is managed to be stored on the local intelligence storage 110 that is independent from a container. In an embodiment, the local intelligence storage 110 may be configured independently from the computing device 100 or may be configured as a specific volume within a storage of the computing device 100. In order to configure the local intelligence storage 110, a host volume may be mounted in a container deployed through cloud technology (e.g., Kubernetes) such that the container may access the local intelligence storage 110.

The local intelligence/model management unit 120 extracts metadata information on the deep learning model stored in the specific volume and generates information on the deep learning model installed in computing resources.

Then, the local intelligence/model management unit 120 scans the local intelligence storage 110 to identify information on the deep learning model installed in the computing device 100. In this case, the deep learning model information may include information related to at least one of a model name, a model version, a model creator (a manufacturer, a developer, etc.), and a model operation environment (a deep learning operation platform) of the deep learning model.

In addition, as an embodiment, the local intelligence/model management unit 120 may provide the identified information on the deep learning model to the outside through a network interface. Based on the information, an administrator may identify the information on the deep learning model installed in the computing device 100 and perform management tasks, such as installation, deletion, or update of the deep learning model, as needed. In this case, the network interface may operate based on hypertext transfer protocol (HTTP) or another network protocol.

In an embodiment, the local intelligence/model management unit 120 may receive a request to identify information on a deep learning model installed in current resources, a request to install a specific deep learning model, and a request to delete a specific deep learning model from the administrator through the network interface. In this case, the information on the deep learning model transmitted and received in response to the request of the administrator may include the name of the deep learning model, version information of the deep learning model, and the like.

For example, the local intelligence/model management unit 120 may, upon receiving a request to install a deep learning model through the network interface, install the deep learning model corresponding to the installation request to be located on the local intelligence storage 110. In addition, the local intelligence/model management unit 120 may broadcast information on the newly installed deep learning model to a container in the computing resources.

The broadcasted information may be used to enable the container to recognize the new deep learning model and use the deep learning model, and the container, after receiving the deep learning model information, may utilize the deep learning model to perform deep learning inference or other AI tasks.

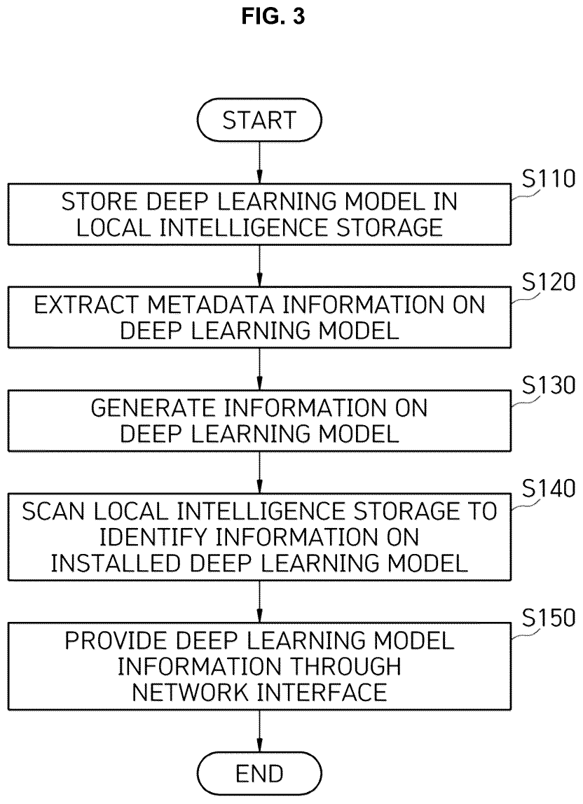

FIG. 3 is a flowchart of a method of managing deep learning models in a computing device 100 according to an embodiment of the present disclosure.

First, a deep learning model for an AI application based on a container is stored in a local intelligence storage 110 that is independent from the container (S110).

Next, metadata information on the deep learning model stored in a specific volume is extracted (S120), and information on the deep learning model installed in computing resources is generated (S130).

Next, the local intelligence storage 110 is scanned to identify the information on the deep learning model installed in the computing device 100 (S140), and the identified information on the deep learning model is provided to the outside through a network interface (S150).

Meanwhile, in the above description, operations S110 to S150 may be further segmented into a larger number of operations or combined into a smaller number of operations according to examples of implementation of the present disclosure. In addition, some of the operations may be omitted or may be executed in the reverse order as needed. Parts, which have been described above with reference to FIG. 2 and omitted in the following description, may be applied to the description shown in FIG. 3.

The method of managing a deep learning model in a computing device according to the embodiment of the present disclosure described above may be implemented as a program (or an application) to be executed in combination with a server, which is hardware, and stored in a medium.

The above described program may include codes coded in a computer language, such as C, C++, Java, Ruby, another machine language, etc., that can be read by a processor (e.g., a CPU) of a computer through a device interface of the computer in order for the computer to read the program and execute the methods implemented as the program. The code may include a functional code that is related to a function that defines functions needed to execute the methods and may include an execution-procedure-related control code needed to cause the processor of the computer to execute the functions according to a predetermined procedure. In addition, the code may further include a memory-reference-related code indicating whether additional information or media needed to cause the processor of the computer to execute the functions should be referred to at a location (an address) of an internal or external memory of the computer. In addition, when the processor of the computer needs to communicate with any other computers or servers, etc. at a remote site, to perform the above-described functions, the code may further include communication-related codes such as those indicating how to communicate with any other computers or servers at a remote site and what information or media should be transmitted or received during communication.

The storage medium is not a medium that stores data for a short period of time, such as a register, cache, memory, etc., but is a medium that stores data semi-permanently and can be read by a device. Specifically, examples of the storage medium include may include a read only memory (ROM), a random-access memory (RAM), a compact disc ROM (CD-ROM), a magnetic tape, a floppy disk, an optical data storage device, etc., but the storage medium is not limited thereto. That is, the program may be stored in various recording media on various servers which the computer can access or on various recording media on the computer of the user. In addition, the medium may be distributed over computer systems connected through a network so that computer-readable codes may be stored in a distributed manner.

The operations of a method or algorithm described in connection with an embodiment of the present disclosure may be implemented directly by hardware, by a software module executed by hardware, or by a combination of hardware and a software module. The software module may reside in a RAM, a ROM, an erasable programmable ROM (EPROM), an electrically EPROM (EEPROM), a flash memory, a hard disk, a removable disk, a CD-ROM, or any other type of computer-readable recording medium well known in the art to which the present disclosure pertains.

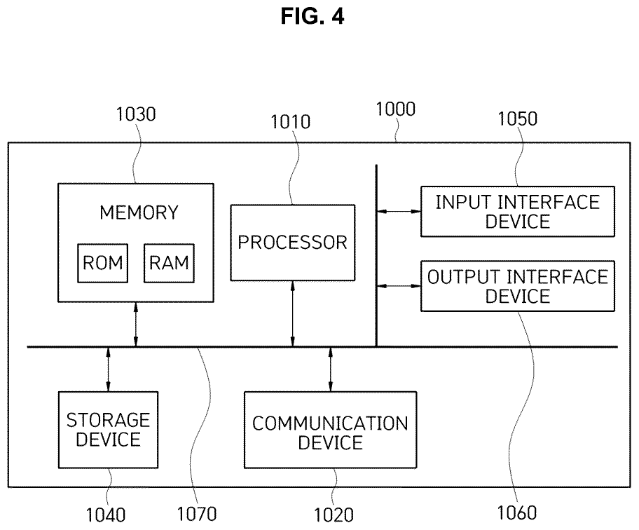

FIG. 4 is a block diagram illustrating a configuration of a computing device according to an embodiment of the present disclosure. The computing device 100 according to the embodiment of the present disclosure may be implemented in the form of a computer system as shown in FIG. 4.

As described above, the computing device 100 performs a method of managing a deep learning model according to one embodiment of the present disclosure.

Referring to FIG. 4, the computing device 100 may include at least one of a processor 1010, a memory 1030, an input interface device 1050, an output interface device 1060, and a storage device 1040, which communicate through a bus 1070. The computing device 100 may further include a communication device (or a communication interface) 1020 coupled to a network.

The processor 1010 may be a central processing unit (CPU) or a semiconductor device for executing instructions stored in the memory 1030 and/or storage device 1040. The memory 1030 and the storage device 1040 may include various types of volatile or nonvolatile media. For example, the memory 1030 may include a ROM or a RAM. The memory 1030 may be located inside or outside the processor 1010 and may be connected to the processor 1010 through various known means. The memory 1030 may include various forms of volatile or nonvolatile media, for example, a ROM or a RAM.

Accordingly, embodiments of the present disclosure may be embodied as a method implemented by a computer or non-transitory computer readable media in which computer executable instructions are stored. According to an embodiment, when executed by a processor 1010, computer readable instructions may perform a method according to at least one aspect of the present disclosure.

The communication device 1020 may transmit or receive a signal in a wired or wireless communication manner.

In addition, the method of managing a deep learning model according to the present disclosure may be implemented in the form of program instructions executable by various computer means and may be recorded on computer readable media.

The computer readable media may be provided with program instructions, data files, data structures, and the like alone or in combination. The program instructions stored in the computer readable media may be specially designed and constructed for the purposes of the present disclosure or may be well known and available to those skilled in the art of computer software. The computer readable storage media include hardware devices configured to store and execute program instructions. For example, the computer readable storage media include magnetic media such as hard disks, floppy disks, and magnetic tape, optical media such as a CD-ROM and a digital video disk (DVD), magneto-optical media such as floptical disks, a ROM, a RAM, a flash memory, etc. The program instructions include not only machine language code made by a compiler but also high level code that can be used by an interpreter etc., which is executed by a computer.

The processor 1010 may be implemented to execute computer readable instructions, which are stored in the memory 1030 or the storage device 1040, to scan the local intelligence storage 110, in which a deep learning model for an AI application based on a container is stored, to identify information on the deep learning model and provide the information on the deep learning model to the outside through the communication device 1020.

The local intelligence storage 110 stores the deep learning model independently from the container.

The local intelligence storage 110 may be configured independently from the computing device 100, and may be configured as a specific volume within the storage device 1040 included in the computing device 100.

The information on the deep learning model may include information related to at least one of a model name, a model version, a model creator, and a model operating environment of the deep learning model.

The processor 1010, upon receiving an installation request of a deep learning model through the communication device 1020, installs the deep learning model corresponding to the installation request to be located on the local intelligence storage 110.

The processor 1010 may broadcast information on the deep learning model installed on the local intelligence storage 110 to the container within computing resources.

Meanwhile, parts, which have been described above with reference to FIGS. 1 to 3 and omitted in the description of FIG. 4, may be applied to the description shown in FIG. 4.

As is apparent from the above, according to an embodiment of the present disclosure, by supporting deep learning model management in units of computing devices (cloud or edge) rather than in units of application containers, deep learning models that were dependent on application containers can be managed independently from application containers.

Such a configuration allows for easy deployment and update of new versions of deep learning models and minimizes service delays.

The effects of the present disclosure are not limited to the effects described above, and other effects that are not described will be clearly understood by those skilled in the art from the above detailed description.

Although the present disclosure has been described with reference to embodiments illustrated in the drawings, the embodiments disclosed above should be construed as being illustrative rather than limiting the present disclosure, and those skilled in the art should appreciate that various substitutions, modifications, and changes are possible without departing from the scope and spirit of the present disclosure. Therefore, the scope of the present disclosure is defined by the appended claims rather than by the foregoing description, and all changes or modifications derived from the meaning and scope of the claims and the equivalents thereof should be interpreted as being included in the scope of the present disclosure.

What is claimed is:

1. A computing device for operating an artificial intelligence (AI) service, comprising:
a communication interface configured to transmit and receive signals in a wired or wireless communication manner;
a memory storing computer-readable instructions; and
at least one processor configured to execute the instructions to:
scan a local intelligence storage, in which a deep learning model for an AI application based on a container in a computing device is stored,
identify information on the deep learning model, and
provide the information on the deep learning model to an outside through the communication interface,
wherein the local intelligence storage stores the deep learning model independently from the container.

2. The computing device of claim 1, wherein the local intelligence storage is configured to independently operate from the computing device.

3. The computing device of claim 1, wherein the local intelligence storage is configured as a specific volume within a storage device included in the computing device.

4. The computing device of claim 1, wherein the information on the deep learning model includes information related to at least one of a model name, a model version, a model creator, or a model operating environment of the deep learning model.

5. The computing device of claim 1, wherein the at least one processor, in response to receiving an installation request of a deep learning model through the communication device, is configured to install the deep learning model corresponding to the installation request to be located on the local intelligence storage.

6. The computing device of claim 5, wherein the at least one processor is configured to broadcast information on the installed deep learning model to the container within computing resources.

7. A method of managing a deep learning model in a computing device, which is performed by the computing device, the method comprising:
storing a deep learning model for an artificial intelligence (AI) application based on a container in a local intelligence storage that is independent from the container;
scanning the local intelligence storage to identify information on the deep learning model installed on the computing device; and
providing the identified information on the deep learning model through a network interface.

8. The method of claim 7, further comprising:
receiving an installation request of a deep learning model through the network interface;
installing the deep learning model corresponding to the installation request to be located on the local intelligence storage; and
broadcasting information on the installed deep learning model to the container within computing resources.
